(19) United States
(12) Patent Application Publication
(10) Pub. No.: US 2022/0006978 A1
(43) Pub. Date: Jan. 6, 2022

(54) INFORMATION PROCESSING APPARATUS, INFORMATION PROCESSING METHOD, AND MOVING OBJECT

(71) Applicant: Toyota Jidosha Kabushiki Kaisha, Toyota-shi (JP)

(72) Inventors: Yu Nagata, Chofu-shi (JP); Yurika Tanaka, Yokosuka-shi (JP); Satoshi Komamine, Nagoya-shi (JP); Kenichi Yamada, Nisshin-shi (JP); Ryuichi Kamaga, Nisshin-shi (JP); Ai Miyata, Okazaki-shi (JP); Shintaro Matsutani, Kariya-shi (JP)

(21) Appl. No.: 17/357,117

(22) Filed: Jun. 24, 2021

(30) Foreign Application Priority Data
Jul. 1, 2020 (JP) 2020-114119

(51) Int. Cl. H04N 7/18; G06Q 10/06; G06K 9/00

(52) U.S. Cl. CPC H04N 7/185; G06K 9/0063; G06Q 10/06311

(57) ABSTRACT

A controller is provided that performs obtaining information on a demand for a moving object to follow a user, and transmitting information about the user to the moving object so that the moving object follows the user when the user has a demand for the moving object.

### CROSS REFERENCE TO THE RELATED APPLICATION

This application claims the benefit of Japanese Patent Application No. 2020-114119, filed on Jul. 1, 2020, which is hereby incorporated by reference herein in its entirety.

### BACKGROUND

### Technical Field

The present disclosure relates to an information processing apparatus, an information processing method, and a moving object.

### Description of the Related Art

There have been known technologies that propose surveillance by drones in areas and at times when crimes or accidents are likely to occur (see, for example, Patent Literature 1).

### CITATION LIST

### Patent Literature

Patent Literature 1: International Publication No. WO 2017/130902 A1

Patent Literature 2: Japanese Patent Application Laid-Open Publication No. 2017-015460

### SUMMARY

An object of the present disclosure is to provide a technology that enables a user to go out without anxiety.

One aspect of the present disclosure is directed to an information processing apparatus including a controller configured to perform:

obtaining information on a demand for a moving object to follow a user; and

transmitting information about the user to the moving object so as to cause the moving object to follow the user when the user has a demand for the moving object.

Another aspect of the present disclosure is directed to an information processing method for causing a computer to perform:

obtaining information on a demand for a moving object to follow a user; and

transmitting information about the user to the moving object so as to cause the moving object to follow the user when the user has a demand for the moving object.

A further aspect of the present disclosure is directed to a moving object including a controller configured to perform:

obtaining information about a user to be followed;

identifying the user based on the information about the user; and

executing processing of following the user.

In addition, a yet further aspect of the present disclosure is directed to a program that causes a computer to execute the processing in the moving object or the information processing apparatus, or is directed a storage medium that stores the program in a non-transitory manner.

According to the present disclosure, it is possible to provide a technology that enables a user to go out without anxiety.

### BRIEF DESCRIPTION OF THE DRAWINGS

FIG. 1 is a diagram illustrating a schematic configuration of a system according to an embodiment;

FIG. 2 is a block diagram schematically illustrating an example of a configuration of each of a drone, a user terminal and a center server, which together constitute the system according to the embodiment;

FIG. 3 is a diagram illustrating a functional configuration of the drone;

FIG. 4 is a diagram illustrating an example of a functional configuration of the center server;

FIG. 5 is a diagram illustrating an example of a table structure of a schedule DB;

FIG. 6 is a diagram illustrating an example of scores when priorities are calculated;

FIG. 7 is a diagram illustrating an example of a functional configuration of the user terminal;

FIG. 8 is a sequence diagram of the processing of the system;

FIG. 9 is a flowchart of command generation processing according to a first embodiment;

FIG. 10 is a flowchart of processing of following according to the first embodiment;

FIG. 11 is a flowchart of processing of following according to a second embodiment;

FIG. 12 is a flowchart of command generation processing according to a third embodiment; and

FIG. 13 is a flowchart of response processing according to the third embodiment.

### DETAILED DESCRIPTION

A controller included in an information processing apparatus, which is one aspect of the present disclosure, obtains information on a demand for a moving object to follow a user. The moving object is, for example, a vehicle or a drone, and is capable of moving autonomously. The moving object performs autonomous movement so as to move while following a user who is a target to be followed. The information on a demand for a moving object to follow a user is information that allows a user to determine that he or she is going out, and includes, for example, information on a request from the user, or information on a schedule for the user to go out.

In addition, the controller transmits information about the user to the moving object so that the moving object can follow the user, when the user has a demand for the moving object. The user is, for example, a user who is going out, or a user who wants the moving object to follow the user, or a user who considers that it is desirable for the moving object to follow the user. The controller transmits information about the user to the moving object so that the moving object can recognize and follow the user. Accordingly, the information about the user includes, for example, information for identifying the user. In addition, the information about the user can include information for making it easy to find the user (e.g., information on the location and the departure time of the user, or the like).

Here, note that when detecting an abnormal condition (or something wrong) in the user, the moving object may notify it to an external organization. For example, in cases where the user is involved in a crime, the police or security company may be notified. Also, for example, in cases where the user is injured, an ambulance may be called. Whether or not there occurs something wrong with the user can be determined, for example, by analyzing images taken by a camera provided on the moving object. In addition, when the moving object is following the user, for example, the moving object may illuminate an area around the user to assist the movement of the user.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

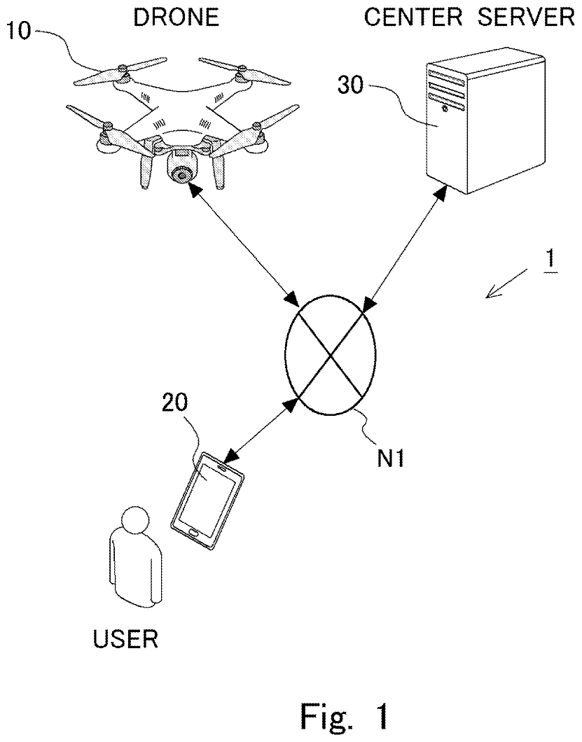

FIG. 1 is a diagram illustrating a schematic configuration of a system 1 according to the present embodiment. The system 1 is a system in which a drone 10 follows and moves with a user, thereby watching over the user. The drone 10 is an example of a moving object.

In the example of FIG. 1, the system 1 includes the drone 10, a user terminal 20, and a center server 30. The drone 10, the user terminal 20, and the center server 30 are connected to one another by means of a network N1. The drone 10 is capable of moving autonomously. The user terminal 20 is a terminal that is used by a user.

The network N1 is, for example, a worldwide public communication network such as the Internet or the like, and a WAN (Wide Area Network) or other communication networks may be adopted. In addition, the network N1 may include a telephone communication network such as a mobile phone network or the like, or a wireless communication network such as Wi-Fi (registered trademark) or the like. Here, note that FIG. 1 illustrates one drone 10 and one user terminal 20 by way of example, but there can be a plurality of drones 10 and a plurality of user terminals 20.

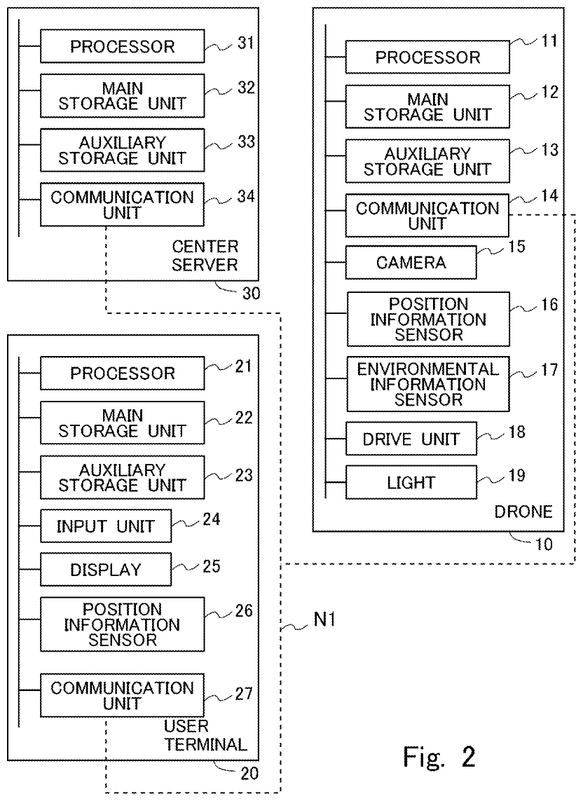

Hardware and functional configurations of the drone 10, the user terminal 20, and the center server 30 will be described based on FIG. 2. FIG. 2 is a block diagram schematically illustrating an example of a configuration of each of the drone 10, the user terminal 20 and the center server 30, which together constitute the system 1 according to the present embodiment.

The center server 30 has a configuration of a general computer. The center server 30 includes a processor 31, a main storage unit 32, an auxiliary storage unit 33, and a communication unit 34. These components are connected to one another by means of a bus. The processor 31 is an example of a controller.

The processor 31 is a CPU (Central Processing Unit), a DSP (Digital Signal Processor), or the like. The processor 31 controls the center server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads the programs stored in the auxiliary storage unit 33 into a work area of the main storage unit 32 and executes the programs, so that each of the component units and the like is controlled through the execution of the programs. Thus, the center server 30 realizes functions matching predetermined purposes, respectively. The main storage unit 32 and the auxiliary storage unit 33 are computer-readable recording media. Here, note that the center server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the drone 10 and the user terminal 20 via the network N1. The communication unit 34 is, for example, a LAN (Local Area Network) interface board, a wireless communication circuit for radio or wireless communication, or the like. The LAN interface board or the wireless communication circuit is connected to the network N1.

Next, the drone 10 is a moving object capable of autonomously flying based on a command received from the center server 30. The drone 10 is, for example, a multicopter. The drone 10 includes a processor 11, a main storage unit 12, an auxiliary storage unit 13, a communication unit 14, a camera 15, a position information sensor 16, an environmental information sensor 17, a drive unit 18, and a light 19. These components are connected to one another by means of a bus. The processor 11, the main storage unit 12, and the auxiliary storage unit 13 are the same as the processor 31, the main storage unit 32, and the auxiliary storage unit 33 of the center server 30, respectively, and hence, the description thereof will be omitted. The processor 11 is an example of a controller.

The communication unit 14 is a communication means for connecting the drone 10 to the network N1. The communication unit 14 is a circuit for performing communication with another device (e.g., the user terminal 20, the center server 30 or the like) via the network N1 by making use of a mobile communication service (e.g., a telephone communication network such as 5th (5G), 4G (4th Generation), 3G (3rd Generation), LTE (Long Term Evolution) or the like), wireless communication such as Wi-Fi (registered trademark), Bluetooth (registered trademark), RFID (Radio Frequency Identification), or the like.

The camera 15 is a device that takes pictures or images of an area around the drone 10. The camera 15 takes pictures by using an imaging element such as a CCD (Charge Coupled Device) image sensor, a CMOS (Complementary Metal Oxide Semiconductor) image sensor or the like. The images thus obtained by taking pictures may be either still images or moving images.

The position information sensor 16 obtains position information (e.g., latitude and longitude) of the drone 10 at predetermined intervals. The position information sensor 16 is, for example, a GPS (Global Positioning System) receiver unit, a wireless communication unit or the like. The information obtained by the position information sensor 16 is recorded in, for example, the auxiliary storage unit 13 or the like, and transmitted to the center server 30.

The environmental information sensor 17 is a means or unit for sensing the state of the drone 10 or sensing the area around the drone 10. As an example of the sensor for sensing the state of the drone 10, there is mentioned a gyro sensor, an acceleration sensor, an azimuth sensor, or the like. Also, as an example of the sensor for sensing the area around the drone 10, there is mentioned a stereo camera, a laser scanner, a LIDAR, a radar, or the like. The camera 15 as described above can also be used as the environmental information sensor 17. The data obtained by the environmental information sensor 17 is also referred to as “environmental data”.

The drive unit 18 is a device for flying the drone 10 based on a control command generated by the processor 11. The drive unit 18 is configured to include, for example, a plurality of motors or the like for driving rotors included in the drone 10, so that the plurality of motors or the like are driven in accordance with the control command, thereby to achieve the autonomous flight of the drone 10. The light 19 is a lighting device that illuminates the area around the drone 10.

Next, the user terminal 20 will be described. The user terminal 20 is a smartphone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, a position information sensor 26, and a communication unit 27. These components are connected to one another by means of a bus. The processor 21, the main storage unit 22 and the auxiliary storage unit 23 are the same as the processor 31, the main storage unit 32 and the auxiliary storage unit 33 of the center server 30, respectively, and hence, the description thereof will be omitted. In addition, the position information sensor 26 is the same as the position information sensor 16 of the drone 10. The information obtained by the position information sensor 26 is recorded in, for example, the auxiliary storage unit 23 or the like, and transmitted to the center server 30.

The input unit 24 is a means or unit for receiving an input operation performed by the user, and is, for example, a touch panel, a mouse, a keyboard, a push button, or the like. The display 25 is a means or unit for presenting information to the user, and is, for example, an LCD (Liquid Crystal Display), an EL (Electroluminescence) panel, or the like. The input unit 24 and the display 25 may be configured as a single touch panel display. The communication unit 27 is a communication means for connecting the user terminal 20 to the network N1. The communication unit 27 is a circuit for communicating with another device (e.g., the drone 10, the center server 30 or the like) via the network N1 by making use of a mobile communication service (e.g., a telephone communication network such as 5G (5th Generation), 4G (4th Generation), 3G (3rd Generation), LTE (Long Term Evolution) or the like), a wireless communication network such as Wi-Fi (registered trademark), Bluetooth (registered trademark), or the like.

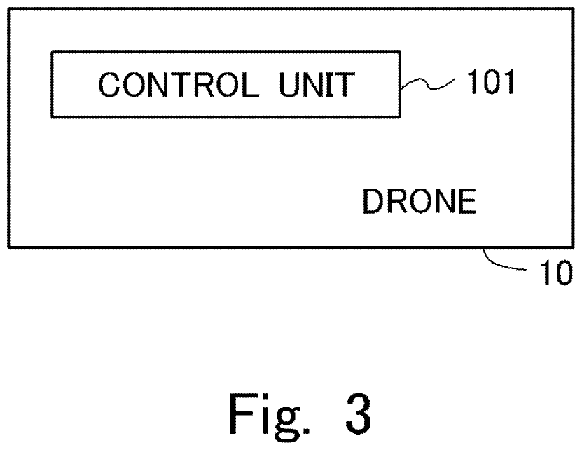

Then, the functions of the drone 10 will be described. FIG. 3 is a diagram illustrating a functional configuration of the drone 10. The drone 10 includes a control unit 101 as its functional component. The processor 11 of the drone 10 executes the processing of the control unit 101 by a computer program on the main storage unit 12. However, some or all of the processing of the control unit 101 may be executed by a hardware circuit, or may be executed by another or other computers connected to the network N1.

The control unit 101 controls the drone 10 during the autonomous flight of the drone 10. The control unit 101 generates a control command for controlling the drive unit 18 by using the environmental data detected by the environmental information sensor 17. The control unit 101 controls, for example, the ascent, descent, forward movement, backward movement, turning and the like of the drone 10 by controlling the plurality of motors to generate differences in rotation speed between the plurality of rotors.

The control unit 101 generates, for example, a flight trajectory of the drone 10 based on the environmental data, and controls the drive unit 18 so that the drone 10 can fly along the flight trajectory. Here, note that as a method of causing the drone 10 to fly in an autonomous manner, there can be adopted a known method. The control unit 101 may perform feedback control based on a detected value of the environmental information sensor 17 during the autonomous flight of the drone 10.

In addition, when receiving information about the user to be followed (hereinafter, also referred to as a first user) from the center server 30, the control unit 101 causes the drone 10 to fly so as to follow the first user. The information about the first user includes information necessary for identifying the first user. For example, the information about the first user includes information necessary for identifying the first user from among a plurality of users (e.g., information on external features of the first user, a face photograph of the first user, an RFID associated with the first user, an identification number of the user terminal 20 associated with the first user, or the like). Moreover, for example, the information about the first user may include information on the current location or the departure place of the first user and information on the time at which the first user departs. The information on the current location or the departure place of the first user is information on the position to which the drone 10 should move.

For example, when obtaining from the center server 30 the external features of the first user and the location information of the first user, the control unit 101 generates a control command to cause the drone 10 to move to that location, and when the drone 10 arrives at that location, the control unit 101 identifies the first user by analyzing the images taken by the camera 15. Note that the external features of the first user may have been registered in advance in the center server 30 by using the user terminal 20. Also, as another method, the face photograph of the first user may have been registered in the center server 30. In addition, as a further method, the control unit 101 may identify the first user by identifying the position of the user terminal 20 of the first user through wireless communication with the user terminal 20. Then, when identifying the first user, the control unit 101 controls the drive unit 18 so that the drone 10 can follow the first user, while maintaining a predetermined distance from the first user. Note that when the area around the first user is dark at night or in a tunnel, the light 19 of the drone 10 may be turned on to illuminate the area around the user. For example, in cases where the drone 10 is provided with an optical sensor, the control unit 101 may determine whether or not to turn on the light 19 based on an output value of the optical sensor. Also, alternatively, the control unit 101 may determine whether or not to turn on the light 19 based on the time of day.

Here, note that a flight route to the current location of the first user may be generated by the control unit 101 of the drone 10 or may be generated by a command unit 302 of the center server 30 which will be described later. In cases where the flight route is generated in the center server 30, the flight route thus generated is transmitted from the center server 30 to the drone 10. Then, the control unit 101 may control the drive unit 18 so that the drone 10 flies according to the generated flight route.

Moreover, the control unit 101 performs the control of moving to follow the first user. For example, when identifying the first user, the control unit 101 follows the first user by making use of image analysis. At that time, for example, the drive unit 18 is controlled so that the distance between the drone 10 and the first user becomes a predetermined distance.

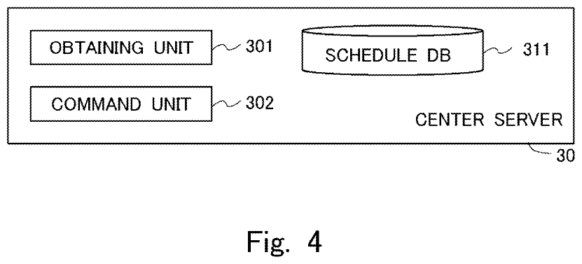

Then, the functions of the center server 30 will be described. FIG. 4 is a diagram illustrating an example of a functional configuration of the center server 30. The center server 30 includes, as its functional components, an obtaining unit 301, the command unit 302, and a schedule DB 311. The processor 31 of the center server 30 performs the processing of the obtaining unit 301 and the command unit 302 by executing a computer program on the main storage unit 32. However, any of the individual functional components or a part of the processing thereof may be implemented by a hardware circuit.

The schedule DB 311 is built by a program of a database management system (DBMS) that is executed by the processor 31 to manage data stored in the auxiliary storage unit 33. The schedule DB 311 is, for example, a relational database.

Here, note that any of the individual functional components of the center server 30 or a part of the processing thereof may be implemented by another or other computers connected to the network N1.

The obtaining unit 301 obtains the schedule of a user from his or her user terminal 20. For example, in cases where an application for managing the schedule of the user is installed in the user terminal 20, the schedule is transmitted from the user terminal 20 by the application. Then, the obtaining unit 301 stores the information on the schedule received in the schedule DB 311. The information on the schedule is obtained as information on the movement or travel of the user. The information on the schedule may include, for example, information on a departure place, a destination place, a departure time, or the like. The obtaining unit 301 obtains information for identifying the user (e.g., a face photograph of the user or information for identifying the user terminal 20) from the user terminal 20. The information for identifying the user may have been registered in advance from the user terminal 20, or may be transmitted from the user terminal 20 together with the schedule.

Further, the obtaining unit obtains the age and gender of the user. The age and gender of the user are used when the priority of the user is calculated, which will be described later. The age and gender of the user may have been registered in advance from the user terminal 20, or may be transmitted from the user terminal 20 together with the schedule. Note that the age and gender of the user are not necessarily required in cases where the priority is not calculated, which will be described later.

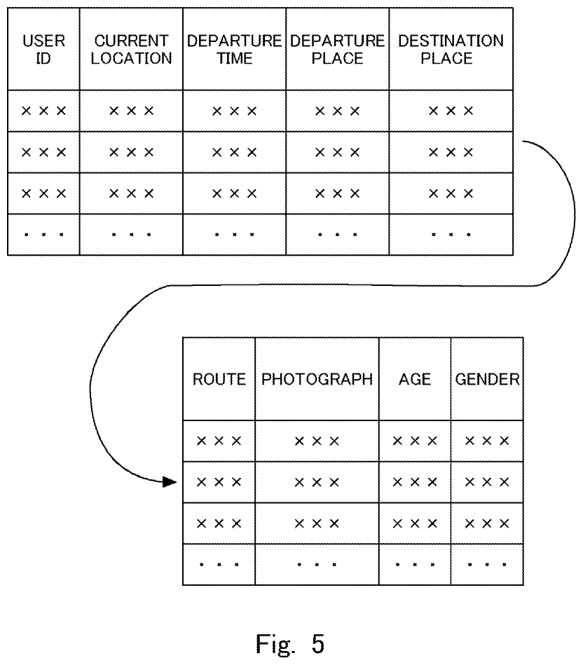

Here, the structure or configuration of the schedule information stored in the schedule DB 311 will be described based on FIG. 5. FIG. 5 is a diagram illustrating an example of the table structure of the schedule DB 311.

The schedule information table includes individual fields of user ID, current location, departure time, departure place, destination place, route, photograph, age, and gender. A user ID, which is identification information for identifying each user, is inputted or entered in the user ID field. A current location of each user is entered in the current location field. The current location of each user is transmitted from his or her user terminal 20 at predetermined time intervals, for example. A departure time at which each user moves is entered in the departure time field. A departure place at which each user moves is entered in the departure place field. A destination place to which each user moves is entered in the destination place field. A route in which each user moves is entered in the route field. Information on a face photograph for identifying each user is entered in the photograph field. Here, note that, instead of the photograph field, a user terminal field may be provided in which identification information for identifying each user terminal 20 is entered. The age of each user is entered in the user age field. The gender of each user is entered in the user gender field.

The departure time, the departure place and the destination place and the destination place to be entered in the schedule DB 311 are included in the information on the schedule transmitted from each user terminal 20. In addition, the route is generated by the obtaining unit 301 based on the departure place and the destination place. Here, note that, as an alternative, a via point(s) may be entered in the route field. The via point(s) may be included in, for example, the information on the schedule. Also, alternatively, the route may be generated by each user terminal 20, or the route along which each user has moved in the past may have been stored in the auxiliary storage unit 33 and may be used. For example, coordinates, an address, a name of a building, or the like is entered as each of the current location, the departure place, and the destination place.

Then, the command unit 302 generates a command (hereinafter, also referred to as a flight command) for dispatching a drone 10 to a user, based on the schedule information stored in the schedule DB 311. The command unit 302, for example, accesses the schedule DB 311, and in cases where there is a field in which a departure time entered in the departure time field of the schedule DB 311 is a predetermined time before the current time, the command unit 302 generates a flight command so that the drone 10 moves to the current location or departure place of the user corresponding to the field, and so that the drone 10 moves to follow the user. Then, the flight command thus generated is transmitted to the drone 10. Here, note that in cases where there are a plurality of drones 10 capable of following the user, the command unit 302 may select, for example, the drone 10 that is the closest to the current location or the departure place of the user, may select the drone 10 having the highest battery charge rate, or may randomly select a drone 10.

Here, note that as an alternative method, the command unit 302 may store the movement history of the user, and may estimate the future movement of the user from this movement history. For example, in cases where there is a user who departs from the same departure place at the same time every day, the drone 10 may be dispatched to that departure place at that time.

Here, note that the command unit 302 may select a user to whom a drone 10 is to be dispatched according to its priority. For example, in cases where a plurality of users go out at the same time, there could be a shortage of drones 10. In this case, a drone 10 may be preferentially dispatched to a user with a high priority. A priority may be set based on, for example, age, gender, route, presence or absence of a request to dispatch a drone 10, or the like. This priority may be calculated based on, for example, a score calculated for each user. This score may be calculated based on, for example, age, gender, and route. For example, scores corresponding to age, gender, and route are set in advance, and by adding or multiplying the respective scores for each user, the priority of the user is calculated. Here, note that the method of calculating priorities is not limited to this. A score corresponding to a route is set so that, for example, the smaller the density of people on that route, or the fewer the number of street lamps thereon, the larger becomes the score.

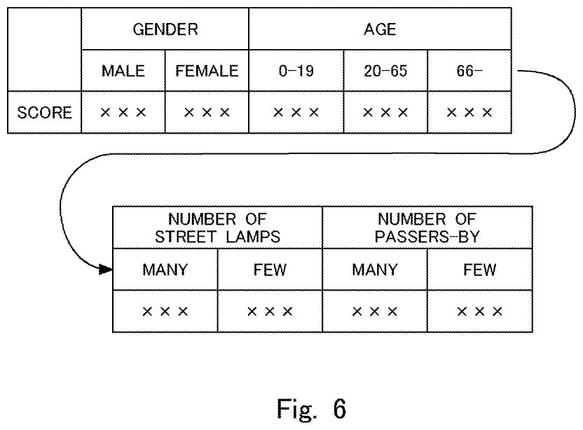

FIG. 6 is a diagram illustrating an example of scores when calculating priorities. For example, the scores according to the gender are set so that the priority of the female is higher than that of the male. In addition, for example, the scores according to the age are set so that the priority of children whose age is lower than a lower limit value or elderly people whose age is higher than an upper limit value is higher than the priority of users of other ages. In FIG. 6, the scores are set for each of three age ranges of 0 to 19 years old, 20 to 65 years old, and 66 years old or more. In addition, for example, the scores may be set according to the number of street lamps so that users who pass through routes with fewer street lamps have a higher priority. The number of street lamps for each road has been stored in advance in the auxiliary storage unit 33. In FIG. 6, for example, when the number of street lamps per predetermined distance is equal to or greater than a first predetermined number, the number of street lamps is determined to be large, whereas when the number of street lamps per predetermined distance is less than the first predetermined number, the number of street lamps is determined to be small, so that the respective scores are set accordingly.

In addition, for example, the scores may be set according to the number of passers-by, so that users who pass through routes with fewer passers-by have a higher priority. For example, the number of passers-by may be obtained by sensing passers-by in real time, or may be obtained from the number of passers-by in the past under the same condition (e.g., on the same day of the week and at the same time), which has been stored in the auxiliary storage unit 33. In FIG. 6, for example, when the number of passers-by per predetermined distance is equal to or more than a second predetermined number, the number of passers-by is determined to be large, whereas when the number of passers-by per predetermined distance is less than the second predetermined number, the number of passers-by is determined to be small, so that the respective scores are set accordingly.

The command unit 302 calculates a value by adding the scores that are obtained from FIG. 6 based on the gender and age of each user as well as the number of street lamps and the number of passers-by on the route, and sets the value as the priority of the user. For example, drones 10 may be dispatched to users having a priority equal to or higher than a predetermined priority, or drones 10 may be dispatched in descending order of priority.

Here, for example, the priorities may be decided such that the priority of users who tend to avoid dark roads is higher than that of users who tend to pass through dark roads frequently. Drones 10 may be dispatched preferentially to users who avoid dark roads, as these users tend to feel uneasy on dark roads.

Here, note that in cases where a drone 10 cannot be dispatched to a user having a relatively high priority, the command unit 302 may suggest other means to the user via the user terminal 20. As another means, for example, the command unit 302 may suggest movement or travel by an autonomous moving vehicle or may suggest waiting until a drone 10 can be dispatched.

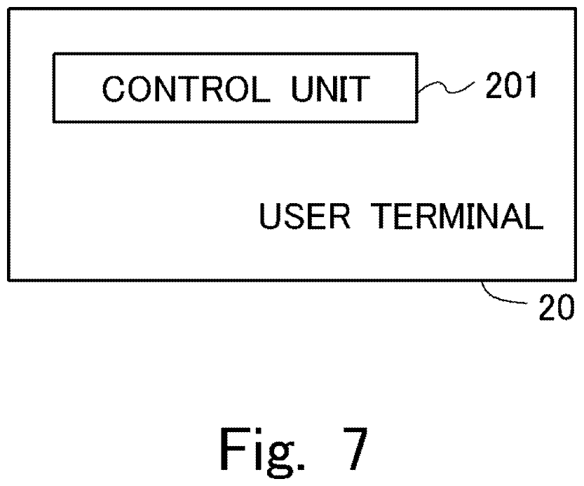

Now, the functions of the user terminal 20 will be described. FIG. 7 is a diagram illustrating an example of a functional configuration of the user terminal 20. The user terminal 20 includes a control unit 201 as its functional component. The processor 21 of the user terminal 20 executes the processing of the control unit 201 by a computer program on the main storage unit 22. The control unit 201 implements, for example, application software for managing a schedule (hereinafter, also referred to as schedule software). The user inputs his or her own schedule to the user terminal 20 via the input unit 24. At this time, the user inputs or enters, for example, a departure time, a departure place, a destination place, and so on. Also, the user can check his or her own schedule via the display 25. In addition, the control unit 201 transmits information on the schedule inputted or entered by the user to the center server 30 in association with a user ID. Moreover, the control unit 201 transmits information about the user (such as a face photograph, age, gender, and the like) to the center server 30 in association with the user ID in accordance with the input of the user to the input unit 24.

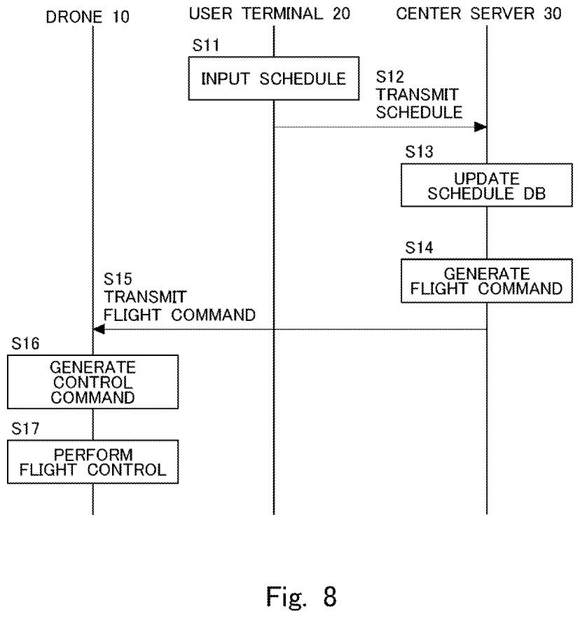

Next, the processing of the system 1 as a whole will be described. FIG. 8 is a sequence diagram of the processing of the system 1. Here, it is assumed that information (such as a face photograph) for identifying a user has been registered in advance in the center server 30. First, when the user inputs a schedule to the user terminal 20 (S11), information on the schedule is transmitted to the center server 30 (S12). In the center server 30, when the information on the schedule is received, the schedule DB 311 is updated (S13). Further, in the center server 30, a flight command is generated based on the information stored in the schedule DB 311 (S14). The flight command thus generated is transmitted from the center server 30 to a drone 10 (S15). This drone 10 is, for example, the drone with its current location nearest to the user.

The drone 10, which has received the flight command, generates a control command for controlling the drive unit 18 based on the flight command (S16). Then, in the drone 10, flight control is performed in accordance with the control command (S17). In this flight control, the drone 10 is controlled so as to move to the current location or the departure place of the user and to follow the user to the destination place of the user.

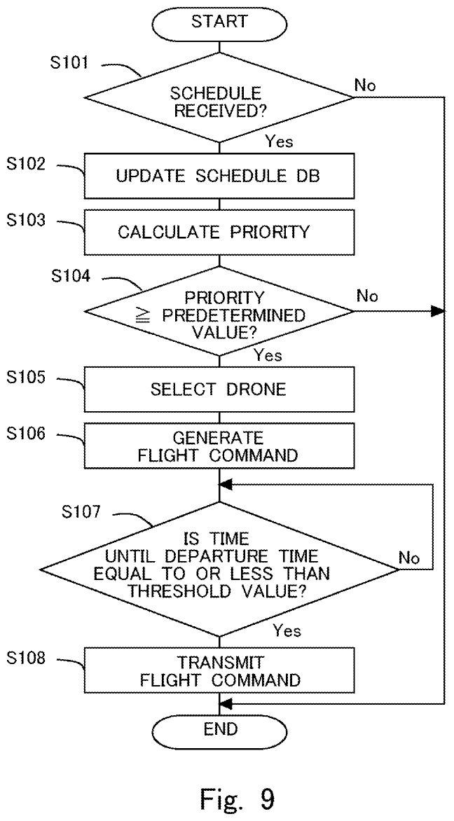

Then, command generation processing in the center server 30 will be described. The command generation processing corresponds to the processing from S12 to S15 in FIG. 8. FIG. 9 is a flowchart of the command generation processing according to the present embodiment. The command generation processing illustrated in FIG. 9 is executed at predetermined time intervals in the center server 30.

In step S101, it is determined whether or not the obtaining unit 301 has received the information on the schedule from the user terminal 20. When an affirmative determination is made in step S101, the processing or routine proceeds to step S102, whereas when a negative determination is made, this routine is ended. In step S102, the obtaining unit 301 updates the schedule DB 311 based on the information on the schedule thus received.

In step S103, the command unit 302 calculates the priority of the user corresponding to the received schedule. The priority is calculated based on, for example, information of the user (e.g., information on age and gender) registered in advance and information on the route of the user. The priority is quantified based on each of the age, the gender and the route of the user, for example. For example, scores corresponding to the age, the gender and the route have been set in advance, and the priority is calculated by adding the individual scores.

In step S104, the command unit 302 determines whether the priority thus calculated is equal to or greater than a predetermined value. The predetermined value is set as a threshold value at which following by a drone 10 is performed. When an affirmative determination is made in step S104, the processing or routine proceeds to step S105, whereas when a negative determination is made, this routine is ended. Here, note that a drone 10 may be dispatched to all users by omitting the processing of step S103 and step S104. In addition, a drone 10 may also be dispatched in order of the departure times of the users without depending on their priorities.

In step S105, the command unit 302 selects a drone 10 that follows the user. For example, the command unit 302 selects a drone 10 that has the shortest distance from the current location or the departure place of the user. In step S106, the command unit 302 generates a flight command. The flight command is generated such that the drone 10 is caused to move to the departure place or the current location of the user and to fly to the destination place of the user, while following the user. The flight command includes information on the departure place of the user and the like. In step S107, the command unit 302 determines whether or not the time until the departure time of the user is equal to or less than a threshold value. The threshold value is set in accordance with the time required for the drone 10 to arrive at the current location or the departure place of the user. When an affirmative determination is made in step S107, the processing proceeds to step S108, whereas when a negative determination is made, the processing in step S107 is executed again. Then, in step S108, the command unit 302 transmits the flight command to the drone 10 selected in step S105.

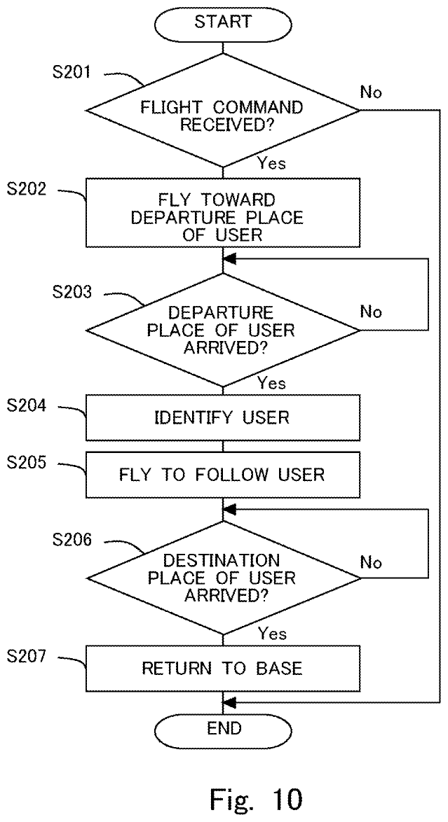

Next, the processing of following in the drone 10 will be described. The processing of following (hereinafter, also referred to as the following processing) corresponds to the processing from S16 to S17 in FIG. 8. FIG. 10 is a flowchart of the following processing according to the present embodiment. The following processing illustrated in FIG. 10 is executed at predetermined time intervals in the drone 10.

In step S201, the control unit 101 determines whether or not a flight command has been received from the center server 30. When an affirmative determination is made in step S201, the processing or routine proceeds to step S202, whereas when a negative determination is made, this routine is ended. In step S202, the control unit 101 generates a control command in accordance with the flight command, and causes the drone 10 to fly toward the departure place of the user. At this time, the control unit 101 controls the drive unit 18 thereby to perform flight control.

In step S203, the control unit 101 determines whether or not the user has arrived at the departure place. Specifically, the control unit 101 determines whether or not the drone 10 has arrived at the departure place of the user, for example, by comparing the position information obtained by the position information sensor 16 with the information on the departure place of the user obtained from the center server 30. When an affirmative determination is made in step S203, the processing proceeds to step S204, whereas when a negative determination is made, the processing of step S203 is executed again.

In step S204, the control unit 101 identifies a user to follow. Information for identifying a user is included in the flight command. For example, a user is identified by making use of face recognition based on a face photograph of the user that has been registered in advance, position information of the user terminal 20, wireless communication with the user terminal 20, or the like. In step S205, the control unit 101 generates a control command to fly the drone 10 to follow the user. For example, the position or location of the user is identified by analyzing the images taken by the camera 15, and the drive unit 18 is controlled so that the distance between the user and the drone 10 becomes a predetermined distance. Here, note that, when the drone 10 follows the user at night (which may be a predetermined time), the area around the user may be illuminated by the light 19 provided on the drone 10.

In step S206, the control unit 101 determines whether or not the user has arrived at the destination place. For example, the control unit 101 determines whether or not the drone 10 has arrived at the destination place of the user, by comparing the position information obtained by the position information sensor 16 with the information on the destination place of the user obtained from the center server 30. When an affirmative determination is made in step S206, the processing proceeds to step S207, whereas when a negative determination is made, the processing of step S206 is executed again. Here, note that, as an alternative, in step S206, it may be determined whether or not the user has entered indoors, or whether or not it is no longer possible to follow the user. In step S207, the control unit 101 causes the drone 10 to fly back to a base of the drone 10. In the base of the drone 10, for example, maintenance or charging of the drone 10 is performed.

As described above, according to the present embodiment, an autonomously movable drone 10 can follow a user in an automatic manner, which can, for example, increase crime prevention, and give the user a sense of security.

### Second Embodiment

In a second embodiment, when it is detected that there is something wrong with a first user, the control unit 101 notifies an external organization. For example, when it is detected that the first user has fallen and is no longer moving, the control unit 101 may notify an external organization to arrange for an ambulance. In addition, for example, when it is detected that the first user has been involved in a crime, the control unit 101 may notify it to the police.

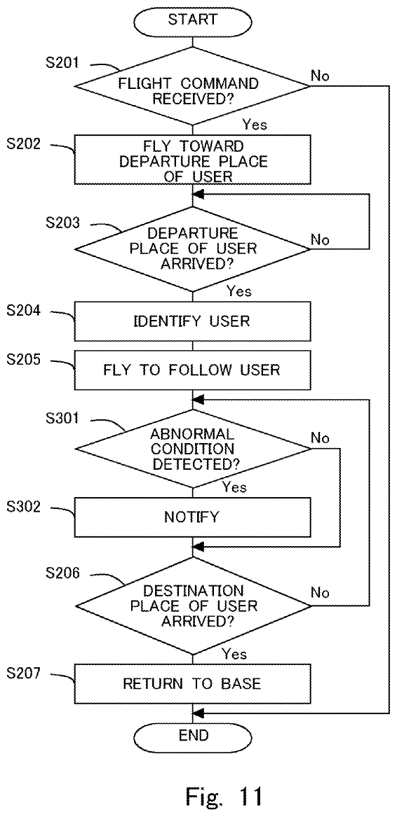

Next, the following processing in the drone 10 will be described. FIG. 11 is a flowchart of the following processing according to the second embodiment. The following processing illustrated in FIG. 11 is executed at predetermined time intervals in the drone 10. Here, note that those steps in which the same processing is performed as in the flowchart illustrated in FIG. 10 are denoted by the same reference signs, and the description thereof will be omitted.

In the flowchart illustrated in FIG. 11, after the processing of step S205, the processing or routine proceeds to step S301. In step S301, the control unit 101 determines whether or not an abnormal condition (or something wrong) has been detected. The control unit 101 detects an abnormal condition, for example, by analyzing the images taken by the camera 15. For example, when the first user has fallen and does not move for a predetermined time or more, it is detected that an abnormal condition has occurred in the first user. For example, when another person is in contact with the first user for a predetermined time or more and the first user is performing a predetermined action, it is detected that an abnormal condition has occurred in the first user. Here, note that the predetermined action is, for example, a dislike action. In addition, an action (which may be a signal) for the first user to notify an abnormal condition may have been determined in advance, and when this action occurs, it may be detected that an abnormal condition has occurred in the first user. When an affirmative determination is made in step S301, the processing proceeds to step S302, whereas when a negative determination is made, the processing proceeds to step S206.

In step S302, the control unit 101 makes a notification. For example, when the first user falls and does not move for a predetermined time or more, the control unit 101 may make a notification to arrange for an ambulance. In addition, for example, when another person is in contact with the first user for a predetermined period of time or more and the first user is performing the predetermined action, the control unit 101 may notify the police to that effect. As an alternative, the control unit 101 may notify the center server 30 that something unusual has happened to the user. Then, the center server 30 may notify the police or the like, for example.

As described above, according to the second embodiment, the autonomously movable drone 10 follows a user in an automatic manner, so that when an abnormal condition occurs in the user, it is automatically notified so that the user can be given a sense of security. In addition, the fact that the drone 10 is following the user also serves as a deterrent to crime.

### Third Embodiment

In a third embodiment, an inquiry is made to a user as to whether or not the user wants to be followed by the drone 10, and the drone 10 is dispatched only when there is a response from the user indicating that the user wants to be followed by the drone 10.

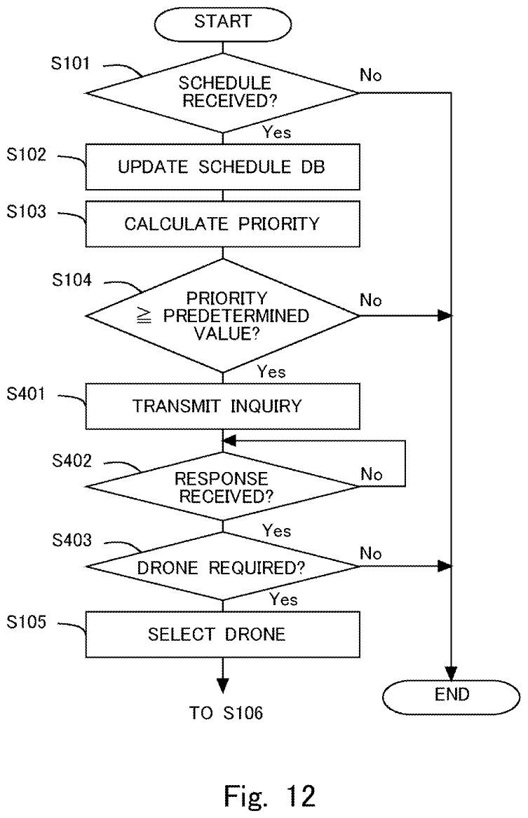

FIG. 12 is a flowchart of the command generation processing according to the third embodiment. The command generation processing illustrated in FIG. 12 is executed at predetermined time intervals in the center server 30. Here, note that those steps in which the same processing is performed as in the flowchart illustrated in FIG. 9 are denoted by the same reference signs, and the description thereof will be omitted. In addition, the processing in and after step S105 in FIG. 12 is the same as in the flowchart illustrated in FIG. 9, and hence, the description thereof will be omitted.

In the flowchart illustrated in FIG. 12, when an affirmative determination is made in step S104, the processing proceeds to step S401. In step S401, the command unit 302 transmits to a user terminal 20 information for inquiring whether or not following by the drone 10 is required. This user terminal 20 is the user terminal 20 that has transmitted the schedule related to the step S101. In step S402, the command unit 302 determines whether or not a response has been received from the user terminal 20. When an affirmative determination is made in step S402, the processing proceeds to step S403, whereas when a negative determination is made, the processing in step S402 is executed again. Here, note that when there is no response from the user for a predetermined period of time, it may be treated as if either an affirmative or negative determination has been made. This treatment has been determined in advance.

In step S403, the command unit 302 determines whether or not the response received from the user terminal 20 is a response indicating that the drone 10 is required. When an affirmative determination is made in step S403, the processing or routine proceeds to step S403, whereas when a negative determination is made, this routine is ended.

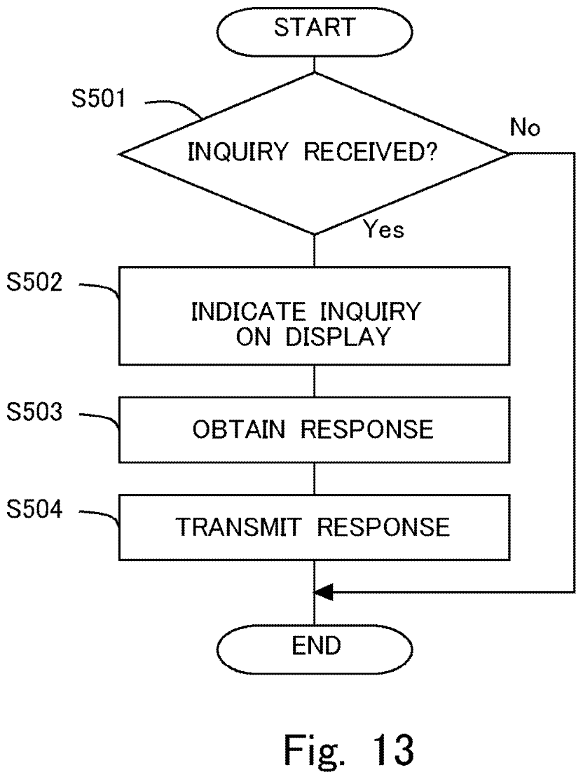

Next, response processing performed by the user terminal 20 will be described. The response processing is for the user terminal 20 to respond to an inquiry from the center server 30. FIG. 13 is a flowchart illustrating a flow or routine of the response processing according to the third embodiment. This routine is executed at predetermined time intervals in the user terminal 20.

In step S501, the control unit 201 determines whether an inquiry has been received from the center server 30. When an affirmative determination is made in step S501, the processing or routine proceeds to step S502, whereas when a negative determination is made, this routine is ended. In step S502, the control unit 201 performs display corresponding to the inquiry from the center server 30 on the display 25. For example, the display 25 indicates whether or not the user wants to dispatch the drone 10, along with a departure place and a departure time. At this time, for example, radio buttons corresponding to YES and NO may be displayed. In step S503, the control unit 201 obtains a response from the user to the inquiry via the input unit 24. The control unit 201 determines, for example, which radio button, YES or NO, has been pressed by the user. Then, in step S504, the control unit 201 transmits the response to the center server 30.

As described above, according to the third embodiment, since the user is inquired about whether or not to dispatch the drone 10, it is possible to prevent the drone 10 from being dispatched more than necessary.

### Other Embodiments

The above-described embodiments are merely examples, but the present disclosure can be implemented with appropriate modifications without departing from the spirit thereof.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system. For example, the center server 30 may include a part or some of the functions of the drone 10. Also, for example, the drone 10 may include a part or all of the functions of the center server 30.

Moreover, in the above-described embodiments, the drone 10 has been described as an example of the moving object, but instead of this, the present disclosure can be applied to, for example, a vehicle capable of traveling autonomously.

In the above-described embodiments, the center server 30, which is provided with the schedule DB 311, grasps the schedule of a user, but as an alternative, the user terminal 20 may grasp the user's schedule and make a request to the center server 30 from the user terminal 20 so that the drone 10 can follow the user, in time for the departure time of the user. In this case, upon receiving the information from the user terminal 20, the center server 30 may dispatch the drone 10 to a designated place.

The present disclosure can also be realized by supplying to a computer a computer program in which the functions described in the above-described embodiments are implemented, and reading out and executing the program by means of one or more processors included in the computer. Such a computer program may be provided to a computer by a non-transitory computer readable storage medium connectable to a system bus of the computer, or may be provided to a computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
obtaining information on a demand for a moving object to follow a user; and
transmitting information about the user to the moving object so as to cause the moving object to follow the user when the user has a demand for the moving object.

2. The information processing apparatus according to claim 1, wherein
the controller obtains information on a schedule of the user as the information on the demand for the moving object to follow the user.

3. The information processing apparatus according to claim 2, wherein
the controller sets, based on the information on the schedule of the user, a timing at which the information about the user is transmitted to the moving object.

4. The information processing apparatus according to claim 1, wherein
the controller transmits, to the moving object, information for identifying the user, information on a departure place of the user, and information on a departure time of the user, as the information about the user.

5. The information processing apparatus according to claim 1, wherein
there are a plurality of users; and
the controller calculates a priority to cause the moving object to follow each of the users, and determines that a user with the priority equal to or higher than a predetermined priority has a demand for the moving object to follow the user.

6. The information processing apparatus according to claim 5, wherein
the controller calculates the priority based on age or gender of the user or a route of the user.

7. The information processing apparatus according to claim 1, wherein
the controller transmits, to a terminal of the user, an inquiry about whether or not the user wants to be followed by the moving object, and determines that there is a demand for the moving object to follow the user, when there is a response from the terminal of the user that the user wants to be followed by the moving object.

8. An information processing method for causing a computer to perform:
obtaining information on a demand for a moving object to follow a user; and
transmitting information about the user to the moving object so as to cause the moving object to follow the user when the user has a demand for the moving object.

9. The information processing method according to claim 8, wherein
the computer obtains information on a schedule of the user as the information on the demand for the moving object to follow the user.

10. The information processing method according to claim 9, wherein
the computer sets, based on the information on the schedule of the user, a timing at which the information about the user is transmitted to the moving object.

11. The information processing method according to claim 8, wherein
the computer transmits, to the moving object, information for identifying the user, information on a departure place of the user, and information on a departure time of the user, as the information about the user.

12. The information processing method according to claim 8, wherein
there are a plurality of users; and
the computer calculates a priority to cause the moving object to follow each of the users, and determines that a user with the priority equal to or higher than a predetermined priority has a demand for the moving object to follow the user.

13. The information processing method according to claim 12, wherein
the computer calculates the priority based on age or gender of the user or a route of the user.

14. The information processing method according to claim 8, wherein
the computer transmits, to a terminal of the user, an inquiry about whether or not the user wants to be followed by the moving object, and determines that there is a demand for the moving object to follow the user, when there is a response from the terminal of the user that the user wants to be followed by the moving object.

15. A moving object including a controller configured to perform:
obtaining information about a user to be followed;
identifying the user based on the information about the user; and
executing processing of following the user.

16. The moving object according to claim 15, wherein
the controller obtains, as the information about the user, information for identifying the user, information on a departure place of the user, and information on a departure time of the user.

17. The moving object according to claim 16, further comprising a drive unit, wherein
the controller further obtains, as the information about the user, information on a destination place of the user, and controls the drive unit so that the moving object follows the user from the departure place of the user to the destination place of the user in the processing of following the user.

18. The moving object according to claim 15, further comprising a sensor, wherein
the controller performs processing of notification when the sensor detects an abnormal condition of the user.

19. The moving object according to claim 18, wherein
the sensor is a camera, and the controller determines whether or not the abnormal condition has occurred in the user by analyzing an image taken by the camera.

20. The moving object according to claim 15, further comprising a light, wherein
the controller turns on the light when following the user at a predetermined time.
